(19) United States
(12) Patent Application Publication
(10) Pub. No.: US 2017/0264978 A1
(43) Pub. Date: Sep. 14, 2017

(54) WEARABLE ELECTRONIC MODULE AND ATTACHMENT SYSTEM

(71) Applicant: Sentrix Technology Limited, Cheung Sha Wan Kowloon (HK)

(72) Inventors: Steven LEFTLY, Christchurch (NZ); Dianne JONES, Christchurch (NZ); Isaac MAN, Kowloon (HK)

(21) Appl. No.: 15/065,921

(22) Filed: Mar. 10, 2016

(51) Int. Cl. H04Q 9/00

(52) U.S. Cl. CPC H04Q 9/00; H04Q 2209/40

(57) ABSTRACT

The present invention provides a novel wearable sensor module system. According to an embodiment, the novel wearable sensor module system includes a wearable electronic sensor module, a multi-layer conductive fabric at least a magnetic fixture, and at least a metallic fixture, wherein said multi-layer fabric makes contact with the metallic fixtures for providing a stable and durable electronic signal communication with the electronic sensor. The electronic sensor module includes an electronic sensor and an electronic contact magnetic fixture. The multi-layer fabric sensor includes an electrically conductive fabric member, a basic fabric and a semiconductor coated fabric. The electrically conductive fabric member and semiconductor coated fabric are in communication with the metallic fixture and magnetic fixture. Further, the metallic fixture is coated with a durable nano particle coating to provide low resistance electrical contact and additional coating to support washable module.

### FIELD OF INVENTION

The embodiments herein generally relates to wearable sensor module system. Specifically, the embodiments described herein relate to a novel wearable sensing electronic module system. Particularly, the embodiments described herein relate to a novel wearable sensing module system having a wearable electronic sensor module, a multi-layer integrated conductive fabric and at least a conductive fixture.

### BACKGROUND OF THE INVENTION

In the earlier period, the size of sensing elements and front-end electronics made it too complicated to use them in a wearable technology for gathering monitoring data. But, now wearable sensors can now be deployed in to digital monitoring systems with the possibility of miniature circuits, front-end amplification, microcontroller operations and wireless data transmission.

Wearable sensor technology embeds advanced electronic technologies incorporated in to clothing and accessories. Modem advancements in telecommunications, sensor manufacturing, microelectronics and data analyzing techniques have opened up new possibilities for using wearable technology in the digital ecosystem for a wide range of monitoring outcomes. The wearable sensor technology integrates a fabric with electronic elements like microcontrollers, sensors and actuators. The fabrics or garments are integrated with information infrastructure and provides information to a user. The sensor can be of heart rate sensors, pressure sensors, temperature sensors etc.

Wearable sensors can be integrated in to various accessories such as garments, hats, wrist bands, socks, shoes, eyeglasses and other devices such as wristwatches. Further, the smart wearable system supports integration of wearable sensors in to miniature electronics to support remote data collection and monitoring with one or more sensors and actuators at the end-user side and can be possibly integrated in to a worn item infrastructure.

But, the problems with the existing system include sensor module which is attached to the garment is not having a rigid attachment system between the sensor module and the garment. Again, good reliability and durability can be other reasons which are not present in the existing art. Further, the fabric attached to the electronic sensor module is not supportive in all times for transferring the signals.

Therefore, there is a need for a novel wearable sensor module system to overcome the problem associated with the prior art. Further, there is a need for a novel wearable sensor module system for attaching and holding an electronic sensor module to a fabric. Still, there is a need for a novel wearable sensor module system having sensor components integrated in to the garment for transferring the signals in a reliable manner.

### SUMMARY OF THE INVENTION

In view of the foregoing, an embodiment herein provides a novel wearable sensor module system. According to an embodiment, the novel wearable sensor module system includes a wearable electronic sensor module, a multi-layer integrated conductive fabric and at least a conductive fixture. The wearable electronic sensor module includes an electronic sensor and at least a self-locating magnetic fixture. The multi-layer integrated conductive fabric includes a basic fabric, an electrically conductive fabric member, and a semiconductor coated fabric. In the fabric, two or more metallic fixtures are attached and are protruded from the fabric. These metallic fixtures are connected directly to the conductive fabric or element/member in the garment and to provide stable electronic contacts on the surface of the fabric or garment.

According to an embodiment, the self-locating magnetic fixture can be recessed in to the electronic sensor module, so that the magnetic fixture can lock the electronic sensor module with the multi-layer conductive fabric. Thus, the electronic sensor module is self-locating for easy attachment. The self-locating magnetic fixtures and metallic fixtures act as electrical contact points joining the electronic sensor module and multi-layer conductive fabric. Further, this arrangement can provide a very strong physical link between the electronic sensor module and the multi-layer conductive fabric.

According to an embodiment, the electrically conductive fabric member is connected and in communication with the electronic sensor module using the self-locating magnetic fixture and metallic fixtures. Further, the semiconductor coated fabric provides a more stable and durable electronic signal communication which takes place between an electronic sensor module and the multi-layer conductive fabric member.

According to an embodiment, the metallic fixtures are made of ferrous material so that they can be connected with the magnetic fixture provided in the electronic sensor module. Further, the metallic fixtures are coated with a durable nano particle coating to provide low resistance electrical contact and to enable precision electronic signal transfer. In addition, the metallic fixtures have extra coating to make them durable to domestic washing and dry-cleaning.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The detailed description is set forth with reference to the accompanying figures. In the figures the use of the same reference numbers in different figures indicates similar or identical items.

FIG. 1 illustrates an exploded view of a novel wearable sensor module system having an electronic sensor module and a multi-layer conductive fabric according to an embodiment therein;

FIG. 2 illustrates a side view of a novel wearable sesnor module system according to an embodiment therein;

FIG. 3 illustrates an underside view of a wearable electronic sensor module according to an embodiment therein; and

FIG. 4 illustrates an exploded view of self locating magnetic fixture with metallic fixture according to an embodiment therein.

FIG. 5 illustrates an exploded view of a wearable electronic sensor module system by using conductive fabric to activate the module with a sliding self-locking attachment;

FIG. 6 illustrates a side view to show a wearable sensor module which is attached on a conductive fabric material;

FIG. 7 illustrates an underside view of a wearable sensor module. The button will be locked by magnets;

FIG. 8 illustrates an exploded view of the custom made button for self-locating magnetic fixture with metallic rivets;

FIG. 9 illustrates another side view showing the button is locked when sliding into the wearable sensor module.

### DETAILED DESCRIPTION OF THE PREFERRED EMBODIMENTS

The embodiments herein and the various features and advantageous details thereof are explained more fully with reference to the non-limiting embodiments and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

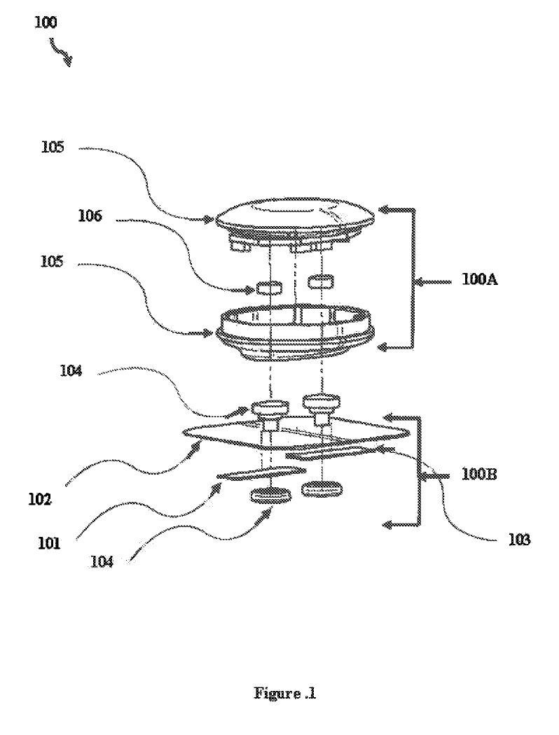

As mentioned above, there is a need for a novel wearable electronic sensor module system. The embodiments herein achieve this by providing a novel wearable electronic sensor module system having an electronic sensor module, a multi-layer conductive fabric, at least a self locating magnetic fixture and at least a metallic fixture. Referring now to drawings, and more particularly to FIGS. 1 through 4, where similar reference characters denote corresponding features consistently throughout the figures, there are shown preferred embodiments.

In accordance with an embodiment, an exploded view 100 of a novel wearable electronic sensor module system having an electronic sensor module and a multi-layer conductive fabric is illustrated in FIG. 1. According to an embodiment, the novel wearable electronic sensor module system 100 includes an electronic sensor module 100A, a multi-layer conductive fabric 100B and at least one self locating magnetic fixture 106 and at least one metallic fixture 104. The electronic sensor module 100A includes an electronic sensor 105 and at least one self locating magnetic fixture 106. The multi-layer conductive fabric includes an electrically conductive fabric member 101, a basic fabric 102 and a semiconductor coated fabric 103, which can be attached to garment. The fabric conductive element 100B is in contact with the metallic fixture 104, which in turn is contact with the magnetic fixture 106 for receiving electrical signal from electronic sensor 105.

According to an embodiment, the electronic sensor module 100A can be constructed with recessed magnetic fixture on the underside. These electronic connection ports can be referred as self locating magnetic fixture 106 and metallic fixture 104 (or ferrous coated burr fixtures) and that can be used to connect between the electronic sensor module 100A and the multi-layer conductive fabric 100B.

According to an embodiment, the metallic fixture 104 can be made of ferrous material so that they can be used as a magnetic source. Further, the metallic fixtures 104 are coated with a durable nano particle coating to provide low resistance electrical contact and to enable precision electronic signal transfer. In addition, the metallic fixtures 104 have extra coating to make them durable to domestic washing and dry-cleaning.

In an embodiment, the semiconductor coated fabric 103 is a fabric coated with semi-conductor nano particles to make contact with the metallic fixture 104, which in turn connect with self locating magnetic fixture 106. The semiconductor coated fabric 103 provides a more stable and durable electronic signal communication that takes place between an electronic sensor module 100A and a multi-layer conductive fabric 100B.

According to an embodiment, the self locating connection between the fabric 100B and the sensor module 100A is achieved by the way of magnetic fixture 106 surfaces are recessed into the module 100A case and the ferrous coated metallic fixture 104 (can be referred as burr) are protruded from the fabric 100B. This arrangement provides a durable locking feature so that the wearing module forms a strong link with the garment so as to feel permanently fixed to the garment surface.

According to an embodiment, two or more ferro metallic fixtures 104 are attached on the multi-layer conductive fabric 100B. These metallic fixtures 104 can be connected directly to the conductive fabric member 100B or element in the garment, and provide stable electronic contacts on the surface of the garment. The connection to the conductive fabric or element in the garment is washable the ferrous metallic fixtures 106 are washable and durable to washing and wearable applications. Further, the metallic fixtures 104 can look like decorative elements on the garment.

In an embodiment, the metallic fixtures 104 can have an electroplated coating for enabling precision electronic signal transfer. The multi layer fabric 100B can be attached to a garment for gathering physiological signals, or transmitting TENs signals or providing some other electronic function directly to the wearer's skin.

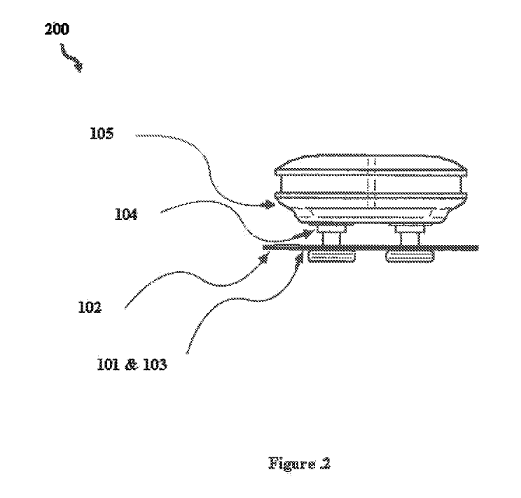

FIG. 2 illustrates a side view of a novel wearable sensor module system according to an embodiment. The metallic fixtures 104 are mounted on a multi-layer fabric 100B comprising an electrically conductive fabric member 101, a basic fabric 102 and a semiconductor coated fabric 103. The electronic sensor module 100A can be firmly attached to the multi-layer fabric 100B which provides a multi-channel electronic connection to the fabric. The self locating magnetic fixture 106 can be recessed in to the electronic sensor module 100A so that the metallic fixture 104 can lock the electronic sensor module 100A with the multi-layer conductive fabric 100B, and also transfer electronic/electrical signal from the sensor to the fabric 100B via the fixtures 104/106. Further, this arrangement can provide a very strong physical link between the electronic sensor module 100A and the multi-layer fabric 100B.

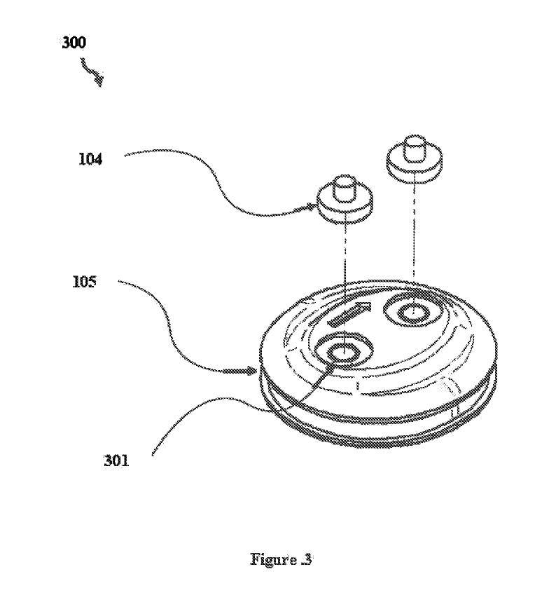

FIG. 3 illustrates an underside view of a wearable electronic sensor module according to an embodiment. The metallic fixture 104 can act as an electrical contact points joining the electronic sensor module 100A and the multi-layer fabric 100B. The self locating magnetic fixtures 106 are magnetically located in the recesses 301 of the wearable electronic sensor module.

According to an embodiment, the electronic sensor module 100A comprises at least an electronic contact magnetic fixture 106 and this forms as a unique amplified magnetic attachment system. The electronic contact magnet fixture 106 can be a ring with a central hole filled with an iron disc. This arrangement provides a stronger magnetic attachment to the garment fixture than a standard fixture.

According to an embodiment, the novel wearing module system provides stable electronic connection for two or more electronic channels and can also be easily removed from the garment but also provides yet strong connection so it can't bump it off during normal wearing conditions. Further, the novel wearing module system acts as the wireless interface to another device for transmitting the signal from the garment to a third party.

In an example embodiment, the novel wearing module does not cause any wearer comfort issues or any aesthetic issues for the fashion clothes.

In an example embodiment, the novel wearing module contains an electronic circuit and components to provide a variety of features not limited to heart rate sensing, breathing sensing, temp sensing, movement sensor, motion sensing, posture sensing, tens application, wireless receiving and transmission of data, emotion sensing, other environmental sensing.

FIG. 4 illustrates an exploded view of self locating electronic contact magnetic fixture with metallic fixture, according to an embodiment. The self locating electronic contact magnetic fixtures 106 can be housed inside the wearable module, wherein the magnetic fixture 106 is a ring with central hole filled with an iron disc. Accordingly, the magnetic fixture 106 comprises a magnet disc 401 with a hole in the centre, attached to a mating iron disc 402.

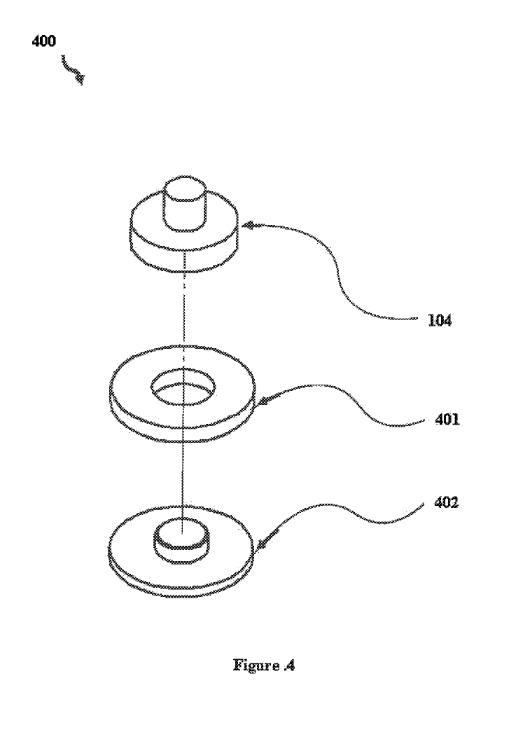

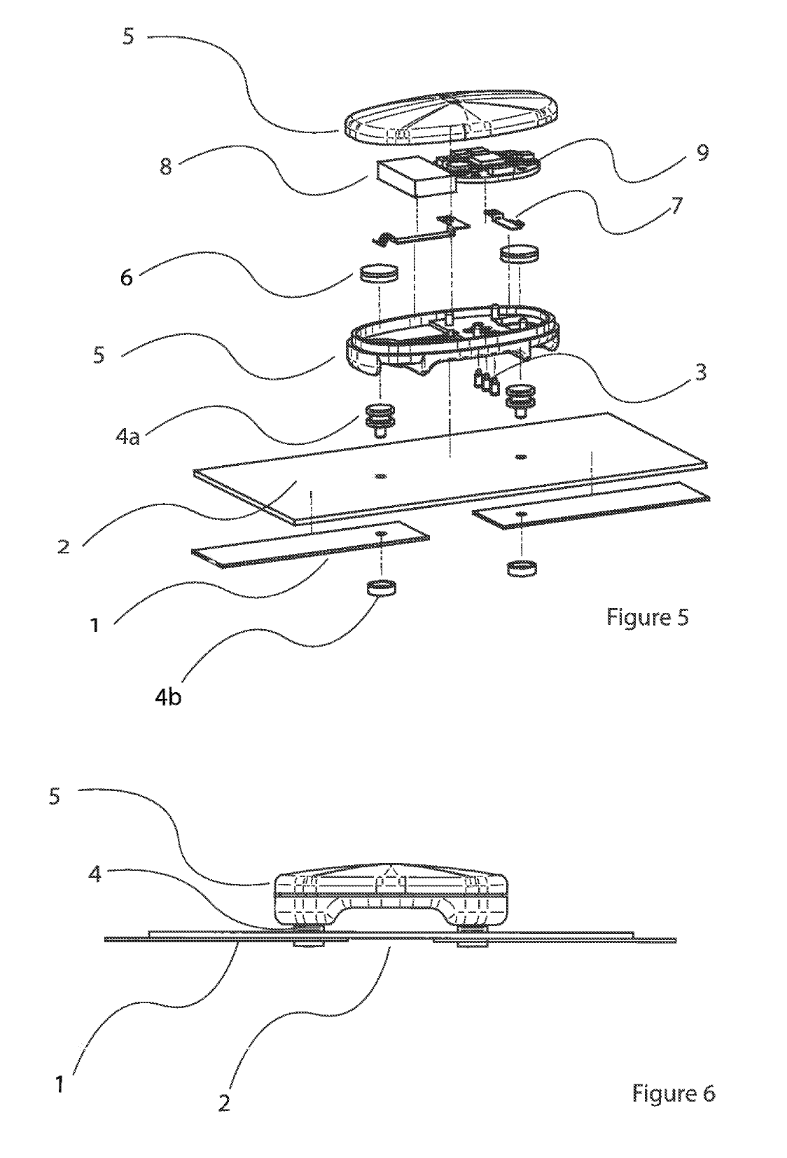

FIG. 5 illustrates an exploded view of a new wearable electronic sensor design with sliding lock features added. The design is aim for portable, presentable and user friendly. The sensor module lower case (5) has a sliding lock feature added. By sliding the button fixture 4a on the bottom cover fixture 5, the module is locked on the fabric fixture 2 firmly.

FIG. 6 illustrates a side view of a fully assembled sensor module which is attached and locked on top of the fabric 2 and metallic fixture 4. Fixture 1 will touch the skin directly and the wearable sensor will start measuring the heartbeat.

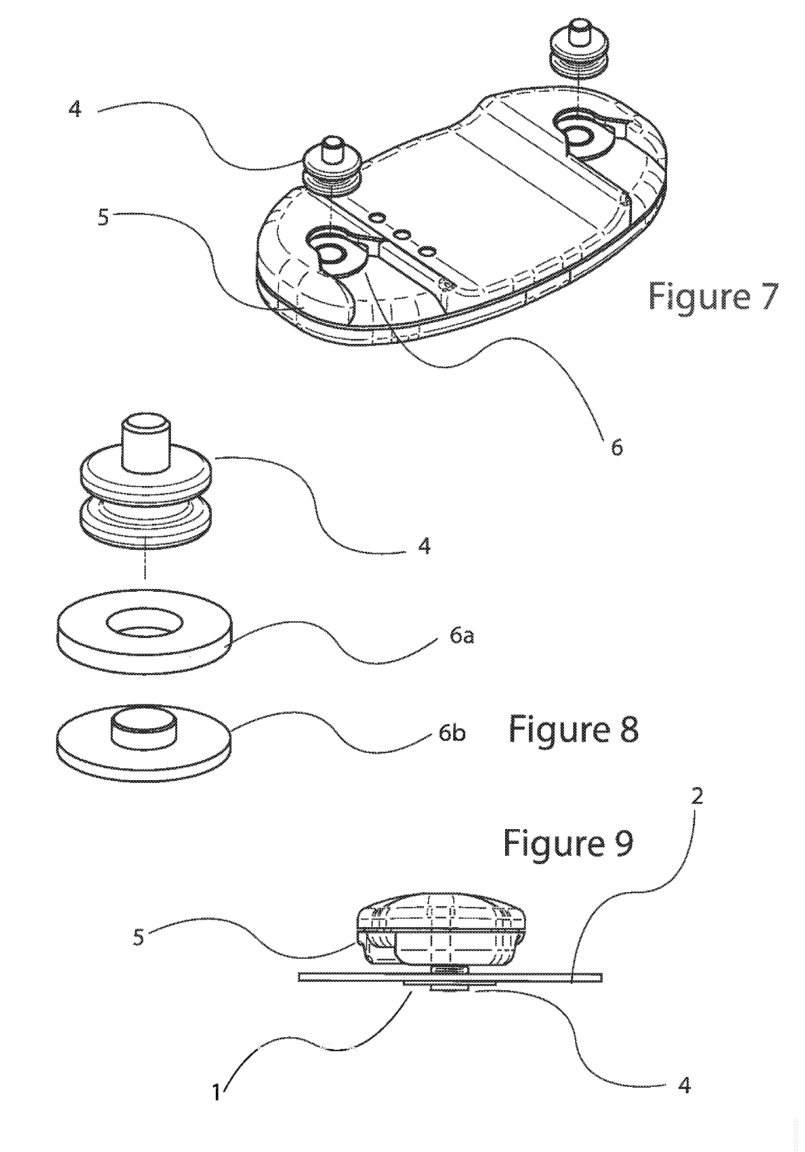

FIG. 7 illustrates how the new button fixture 4 locks in the wearable sensor module fixture 5 firmly in the channels shown here as item 6. There is a magnetic force attracting the button towards the module when the button is placed on the magnet area surface fixture 6. They self-align after attached on the button 4 on the magnet area surface. Once the button and magnet is contacted, the heart rate sensor module can start calculating the heartbeat and transmits the data.

FIG. 8 illustrates an exploded view of self-locating electronic contact magnetic 6a & 6b fixture with metallic fixture 4. There are two steps on the metallic fixture 4. The top fixture is using for electronic connection when the magnet surface is touching the metallic top surface. The second step of the metallic fixture is used for locking between the wearable sensor module and the fabric. The self-locating electronic contact magnetic fixtures 6 can be located inside the wearable module, wherein the magnetic fixture 6a is a ring with central hole filled with an iron disc 6b. Accordingly, the magnetic fixture 6 comprises a magnet disc 6a with a hole in the centre, attached to a mating iron disc 6b.

FIG. 9 illustrates another end/side view of a fully assembled sensor module which is attached and locked on top of the fabric 2 and metallic fixture 4. Fixture 1 will touch the skin directly and the wearable sensor will start measuring the heartbeat.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A novel wearable sensor module system comprising:
a wearable electronic sensor module includes an electronic sensor and at least an magnet fixture;
a multi-layer conductive fabric includes an electrically conductive fabric member, a basic fabric and a semiconductor coated fabric;
at least a metallic fixture connected to said multi-layer conductive fabric;
wherein said multi-layer conductive fabric is in contact with the metallic fixtures for providing a stable and durable electronic signal communication with the electronic sensor.
wherein said magnetic fixture is self locating electronically contactable magnetic material to form a unique electronic contact between said multi-layer conductive fabric and said electronic sensor module and to transfer electrical signal from electronic sensor to the multi-layer conductive fabric through said metallic fixture.

2. The novel wearable sensor module of claim 1, wherein said magnetic fixture includes a magnet ring with an iron plate.

3. The novel wearable sensor module of claim 1, wherein said metallic fixture is made of ferrous material be coated with a durable nano particle coating to provide low resistance electrical contact.

4. The novel wearable sensor module of claim 1, wherein said metallic fixture is further coated to make the said metallic fixtures durable to domestic washing and dry-cleaning.

5. The novel wearable sensor module of claim 1, wherein said electronic sensor module firmly attached to the multi-layer fabric sensor to provide a multi-channel electronic connection to the fabric.

6. The novel wearable sensor module of claim 1, wherein said electronic sensor module firmly attached by magnets with an additional slide locking feature, to the multi-layer fabric sensor to provide a multi-channel electronic connection to the fabric.

7. The novel wearable sensor module of claim 1, wherein said magnetic fixture is recessed in to the electronic sensor so that the self locating magnetic fixture locks with the electronic sensor module.

8. The novel wearing sensor module of claim 1, wherein said novel wearable module attached to a garment for gathering physiological signals, or transmitting TENs signals or providing some other electronic function directly to the wearer's skin.

9. The novel wearing sensor module of claim 1, wherein said novel wearable module contains an electronic circuit and components to provide a variety of features includes of heart rate sensing, breathing sensing, temp sensing, movement sensor, motion sensing, posture sensing, tens application, wireless receiving and transmission of data, emotion sensing, and other environmental sensing.
